(19) United States
(12) Patent Application Publication
(10) Pub. No.: US 2018/0051571 A1
(43) Pub. Date: Feb. 22, 2018

(54) AIRFOIL FOR A TURBINE ENGINE WITH POROUS RIB

(71) Applicant: General Electric Company, Schenectady, NY (US)

(72) Inventor: Ronald Scott Bunker, Placitas, NM (US)

(21) Appl. No.: 15/238,174

(22) Filed: Aug. 16, 2016

(51) Int. Cl. F01D 5/18; F01D 5/28; F01D 9/04; F01D 25/12; F04D 29/54; F04D 29/58; F04D 29/32

(52) U.S. Cl. CPC F01D 5/187; F01D 5/28; F01D 9/041; F01D 25/12; F04D 29/542; F04D 29/582; F05D 2300/514; F05D 2220/32; F05D 2230/30; F05D 2240/126; F05D 2240/301; F05D 2250/185; F05D 2260/22141; F04D 29/324

(57) ABSTRACT

An apparatus and method for cooling an engine airfoil, including a wall bounding an interior extending axially between a leading edge and a trailing edge and radially between a root and a tip. A cooling circuit it located within the interior having full-length ribs and partial-length ribs to define the cooling circuit, with the partial length ribs defining a turn.

### BACKGROUND OF THE INVENTION

Turbine engines, and particularly gas or combustion turbine engines, are rotary engines that extract energy from a flow of combusted gases passing through the engine onto a multitude of rotating turbine blades.

Turbine engines for aircraft, such as gas turbine engines, are often designed to operate at high temperatures to maximize engine efficiency, so cooling of certain engine components, such as the high-pressure turbine and the low-pressure turbine, can be beneficial. Typically, cooling is accomplished by ducting cooler air from the high and/or low-pressure compressors to the engine components that require cooling. Temperatures in the high-pressure turbine are around 1000° C. to 2000° C. and the cooling air from the compressor is around 500° C. to 700° C. While the compressor air is a high temperature, it is cooler relative to the turbine air, and can be used to cool the turbine.

Contemporary turbine components, such as blades, can include one or more interior cooling circuits for routing the cooling air through the component to cool different portions of the component, and can include dedicated cooling circuits for cooling different portions of the component, such as the leading edge, trailing edge, or tip of the blade.

### BRIEF DESCRIPTION OF THE INVENTION

In one aspect, embodiments of the invention relate to a component for a turbine engine. The component includes a wall bounding an interior. A cooling circuit is located in the interior having at least one rib that at least partially defines a flow channel. A porous material is provided in at least one rib to define a flow path through the at least one rib.

In another aspect, embodiments of the invention relate to an airfoil for a turbine engine. The airfoil includes an outer wall bounding an interior and defining a pressure side and a suction side extending axially between a leading edge and a trailing edge to define a chord-wise direction and extending radially between a root and a tip to define a span-wise direction. A cooling circuit is located within the interior and has at least one rib that at least partially defines a flow channel. A porous material is provided in at least one rib to define a flow path through the at least one rib.

In yet another aspect, embodiments of the invention relate to a method of reducing flow separation at a turn in a cooling circuit formed at least in part by a partial-length rib within an interior of an airfoil for a turbine engine. The method includes flowing cooling fluid through a porous material at an end of the partial length rib.

### BRIEF DESCRIPTION OF THE DRAWINGS

In the drawings:

FIG. 1 is a schematic cross-sectional diagram of a gas turbine engine for an aircraft.

FIG. 2 is a perspective view of an airfoil of the gas turbine engine of FIG. 1.

FIG. 3 is a cross-sectional view of the airfoil of FIG. 2 illustrating ribs defining passages within an interior of the airfoil.

FIG. 4 is a section view of the airfoil of FIG. 3 illustrating a cooling circuit within the interior defined by the ribs, with a partial-length rib having a porous portion.

FIG. 5 is a cross-sectional view of a turn in the cooling circuit of FIG. 4 defined by the partial-length rib, with the porous portion spaced from the turn.

FIG. 6 is a cross-sectional view of the partial-length rib of FIG. 5 having a solid structure within the porous portion.

FIG. 7 is a cross-sectional view of an alternative partial-length rib having the porous portion connecting the partial-length rib to a tip, while the porous portion can define the turn.

### DESCRIPTION OF EMBODIMENTS OF THE INVENTION

The described embodiments of the present invention are directed to an airfoil for a turbine engine. For purposes of illustration, the present invention will be described with respect to the airfoil for an aircraft turbine engine. It will be understood, however, that the invention is not so limited and may have general applicability within an engine, including compressors, as well as in non-aircraft applications, such as other mobile applications and non-mobile industrial, commercial, and residential applications. Additionally, the aspects will have applicability outside of an airfoil, and can extend to any engine component requiring cooling, such as a vane, blade, shroud, or a combustion liner in non-limiting examples.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

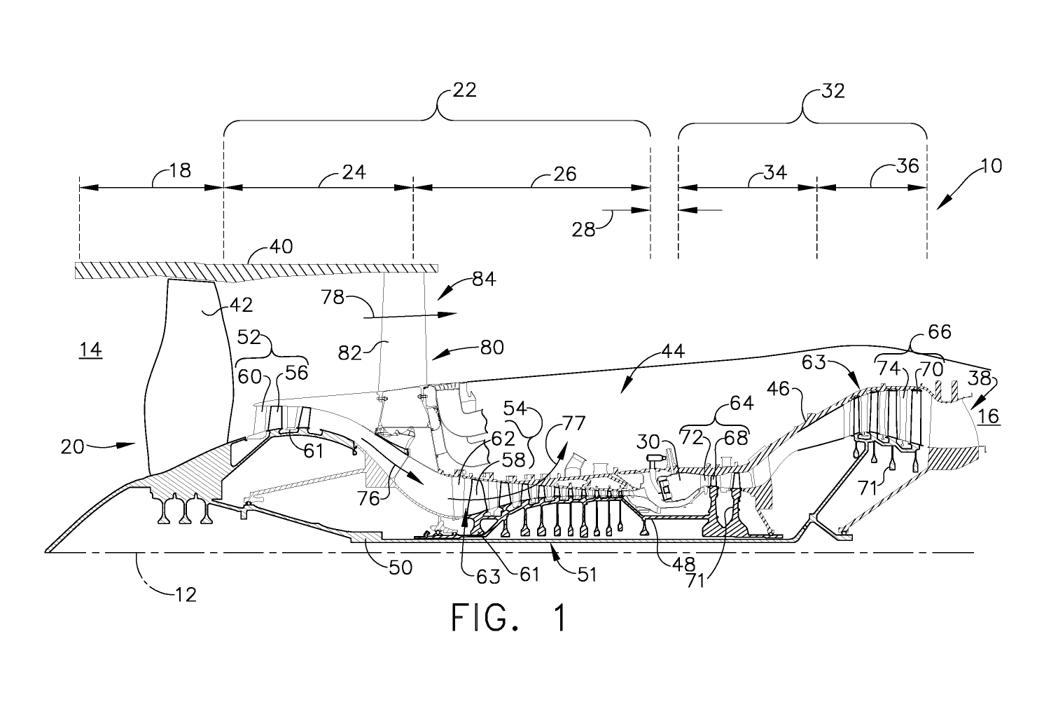

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized airflow 76 to the HP compressor 26, which further pressurizes the air. The pressurized airflow 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be draw from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

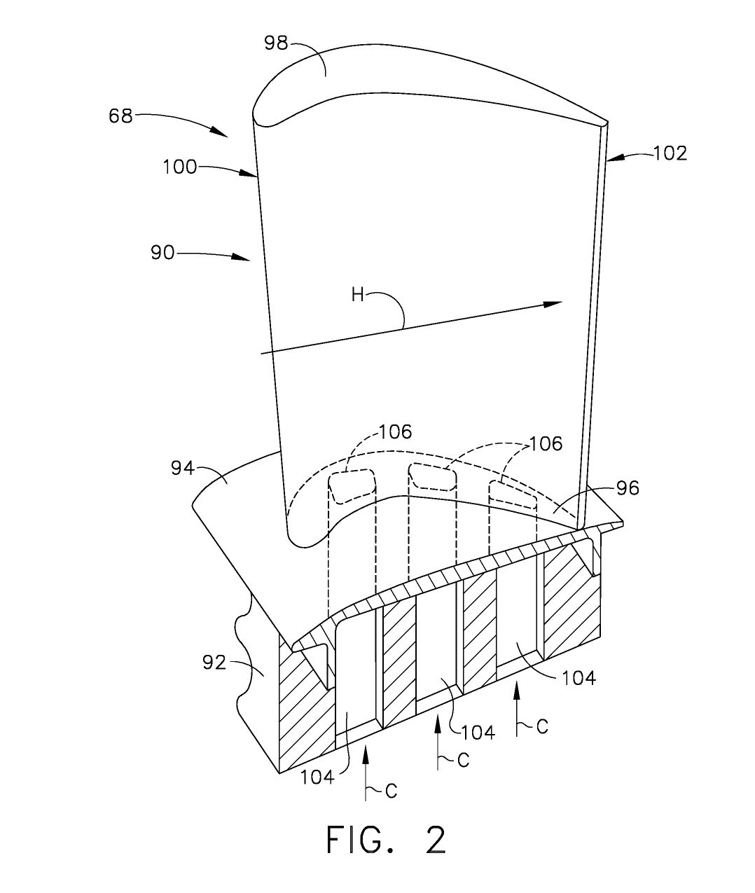

Referring now to FIG. 2, an engine component is shown in the form of an airfoil 90, which can be one of the turbine blades 68 of the engine 10 of FIG. 1. Alternatively, the engine component can include a vane, a shroud, or a combustion liner in non-limiting examples, or any other engine component that can require or utilize cooling. The airfoil 90 includes a dovetail 92 and a platform 94. The airfoil 90 extends radially between a root 96 and a tip 98 defining a span-wise direction. The airfoil 90 extends axially between a leading edge 100 and a trailing edge 102 defining a chord-wise direction. The dovetail 92 can be integral with the platform 94, which can couple to the airfoil 90 at the root 96. The dovetail 92 can be configured to mount to a turbine rotor disk on the engine 10. The platform 94 helps to radially contain the turbine airflow. The dovetail 92 comprises at least one inlet passage, shown as three inlet passages 104, each extending through the dovetail 92 in fluid communication with the airfoil 90 at a passage outlet 106. It should be appreciated that the dovetail 92 is shown in cross-section, such that the inlet passages 104 are housed within the dovetail 92.

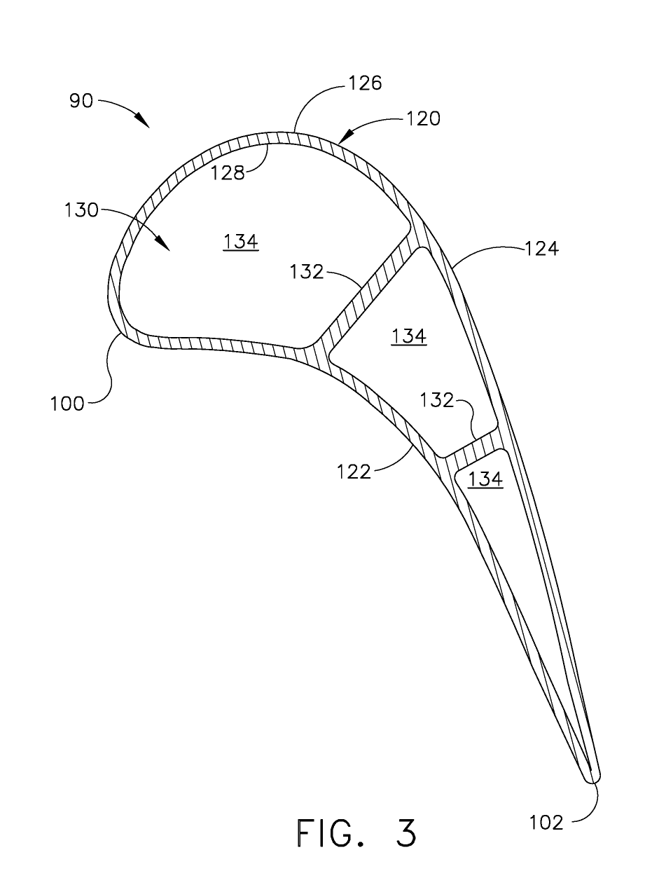

Referring now to FIG. 3, a cross-sectional view of the airfoil 90 illustrates an outer wall 120 including a pressure side 122 and a suction side 124 extending between the leading edge 100 and the trailing edge 102. The outer wall 120 separates the hot fluid flow H external of the airfoil 90 from the cooling fluid flow C within the airfoil 90, having a hot surface 126 along the exterior of the airfoil 90 and a cooling surface 128 confronting the cooling fluid flow C. An interior 130 of the airfoil 90 is defined by the outer wall 120. One or more internal ribs 132 separates the interior 130 into passages 134 extending in the span-wise direction. The passages 134 can define one or more cooling circuits throughout the airfoil 90. Additionally, the cooling circuits can be further includes micro-circuits, sub-circuits, near wall cooling circuits, leading edge passages, trailing edge passages, pin fins, pin banks, additional passages 134, flow enhancers such as turbulators, or any other structures which can define the cooling circuits.

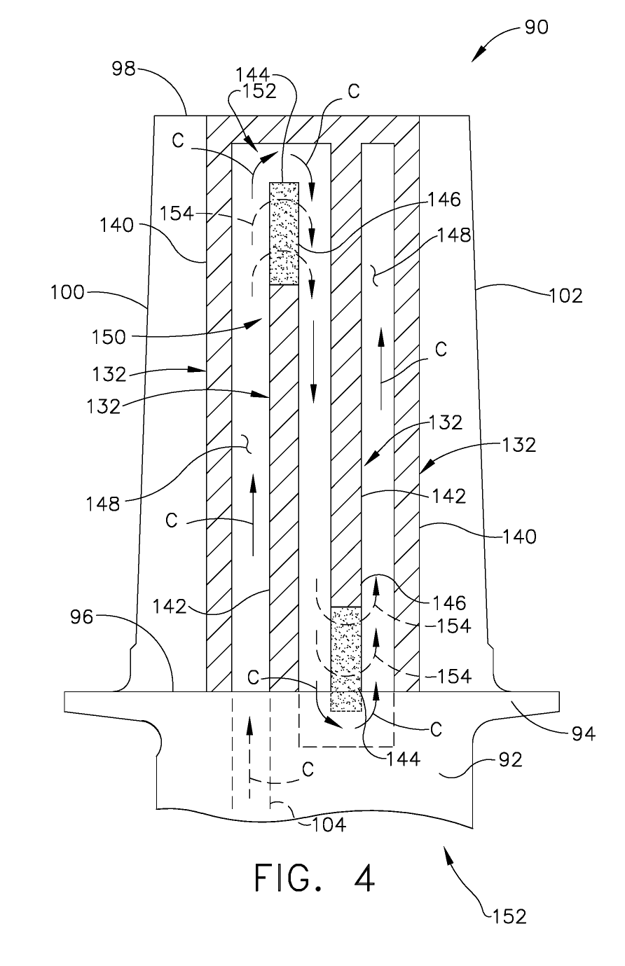

Referring to FIG. 4, a section view of the airfoil 90 illustrates an exemplary system of ribs 132 defining a cooling circuit 150 extending in the span-wise direction within the interior 126. The ribs 132 are separated into first ribs and second ribs, illustrated as full-length ribs 140 and partial length ribs 142, respectively. The full-length ribs 140 extend fully in the span-wise direction between the root 96 and the tip 98. The partial-length ribs 142 extend only partially between the root 96 and the tip 98, terminating at a rib end 144. The partial-length ribs 142 organized between the full-length ribs 140 define a cooling circuit 150, having a substantially serpentine flow path as illustrated. It should be understood that the cooling circuit 150 as illustrated is exemplary, and can include additional structures to form the cooling circuit 150, such as micro-circuits, sub-circuits, near wall cooling circuits, leading edge passages, trailing edge passages, pin fins, pin banks, additional passages 134, or flow enhancers such as turbulators in non-limiting examples.

The partial-length ribs 142 can include a porous portion 146 made of porous material. The porous portions 146 can extend from the rib end 144 radially along at least a portion of the partial-length ribs 142. The porous portions 146 can be made by additive manufacturing, while it is contemplated that additive manufacturing can form the entire airfoil 90. It should be appreciated that any portion of the airfoil 90 can be made by any known method including but not limited to, casting, machining, additive manufacturing, coating, or otherwise.

The porous portions 146 can define a porosity, being permeable by a volume of fluid, such as air. The porous portions 146 can have a particular porosity to meter the flow of a fluid passing through the porous material at a predetermined rate. It should be appreciated that additive manufacturing can be used to achieve a particular local porosity along the porous portions 146, as well as a consistent porosity across the entirety of the porous portions 146, as compared to traditional method of forming the porous portions 146. In alternative examples, the porous portions 146 can be made of any of the materials described above, such that a porosity is defined. In one non-limiting example, the porous portions 146 can be made of Ni, NiCrAlY, NiAl, or similar materials. The porous portions 146 can further be made of a nickel foam, for example.

Additionally, the porous material in the porous portions 146, can be a structured porous material or a random porous material, or a combination thereof. A structured porous material includes a determinative porosity throughout the material, which can have particular local increases or decreases in porosity to meter a flow of fluid passing through the structured porous material. Such local porosities can be determined and controlled during manufacture. Additive manufacturing can be used to form a structured porous material, in one non-limiting example. Alternatively, the porous materials can have a random porosity, such as a non-structured porous material. The random porosity can be adapted to have a porosity as the average porosity over an area of the porous material, having discrete variable porosities that are random. A random porous material can be made from a nickel foam, in one non-limiting example.

A plurality of flow channels 148 can be defined between adjacent ribs 132 to further define the cooling circuit 150. The partial-length ribs 142 at the rib end 144 forms a turn 152 within the cooling circuit, such as a tip turn or a root turn. The turns 152 include about a 180-degree change in direction from moving radially inward to radially outward relative to the engine centerline 12 (FIG. 2).

The flow of cooling fluid C can be provided to the cooling circuit 150 from the inlet passage 104 in the dovetail 92. The flow of cooling fluid C can pass through the serpentine path of the cooling circuit 150. The flow cooling fluid C turns within the turns 152. Additionally, a portion 154 of the flow of cooling fluid C can pass through the porous portions 146, bypassing the turns 152. The porosity of the porous portions 146 can be adapted to determine the flow rate of the portion of cooling fluid 154 through the porous portions 146.

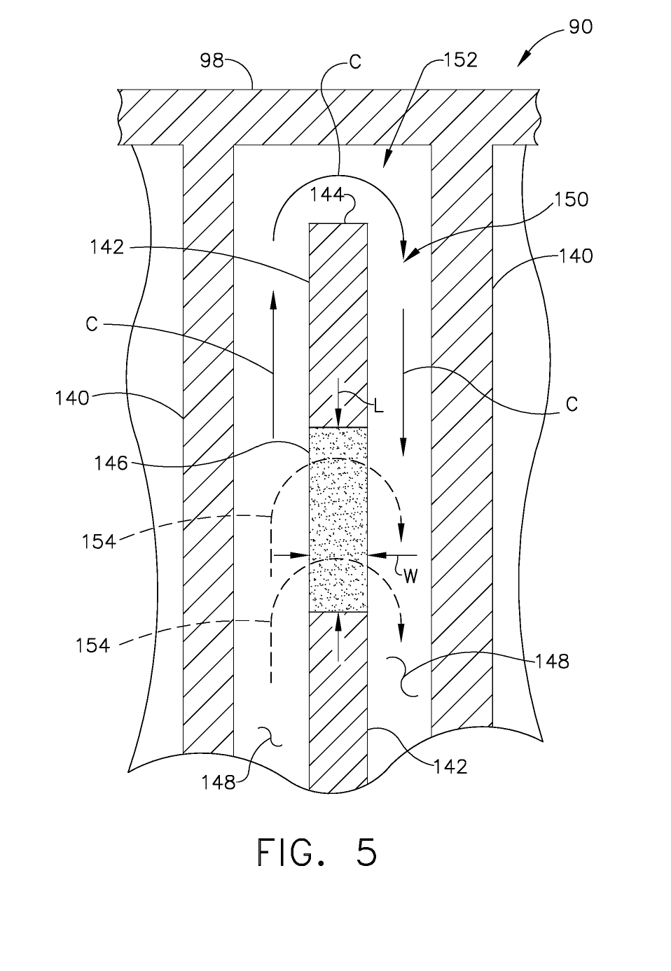

Referring now to FIG. 5, illustrating one exemplary position for the porous portion 146, as positioned along the partial-length rib 142, being spaced from the rib end 144. The porous portion 146, in one example, can be spaced from the rib end 144 by a distance less than or equal to a length L of the porous portion 146. Alternatively, the porous portion 146 can be space from the rib end 144 by a distance of less than three times a width W of the porous portion 146. In another example, the porous portion 146 need not extend full through the rib 142 between the pressure side 122 and the suction side 124, but can extend only partially through the rib 142 with the porous portion 146 adjacent the pressure side 122, the suction side 124, or disposed in the middle of the rib 132. Furthermore, it is contemplated that the porous portion 146 can be positioned anywhere along the partial-length rib 142, however it is advantageous to place the porous portion 146 near to the turn 152 to prevent any cycling of the cooling fluid flow C through the cooling circuit 150.

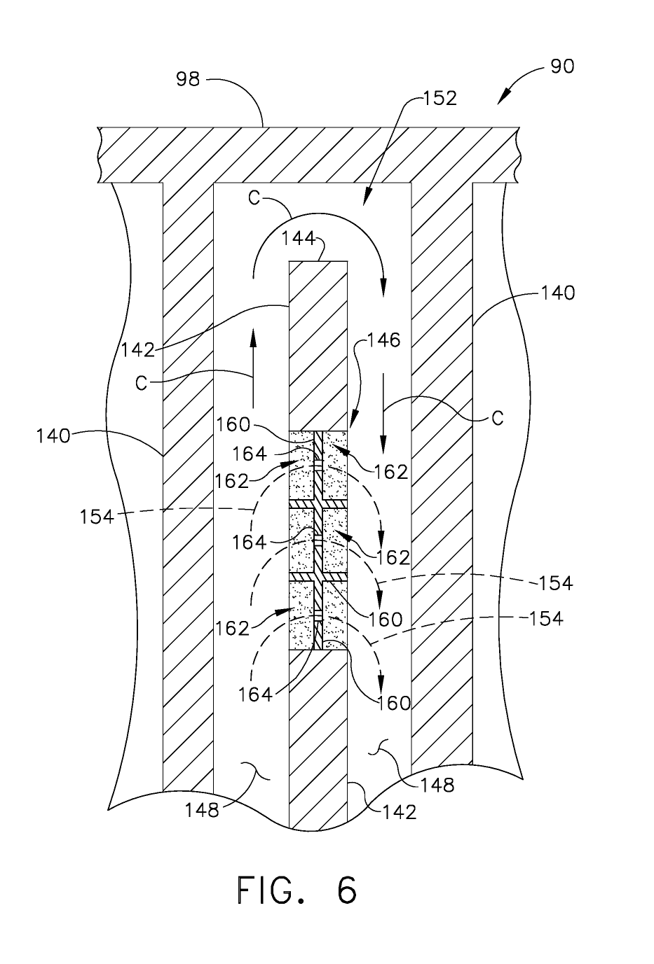

Referring now to FIG. 6, the porous portion 146 can include a framework 160, which can be made of a plurality of solid elements. The framework 160 can be a single integral unit, or can be multiple discrete elements. In the case of multiple discrete elements, some or none of the framework 160 can couple to one another. The framework 160 can be linear, curved, or any combination thereof, having any cross-sectional shape or profile, such that any geometry is contemplated. As such, a myriad of framework 160 disposed within the porous portion are contemplated.

A plurality of interstitial spaces 162 are defined between the framework 160. The porous material of the porous portion 146 can fill the interstitial spaces 162. Discrete orifices 164 can be formed in the framework 160 to provide a flow path for the portion of cooling fluid 154 to pass through the framework 160 within the porous portion 146.

As such, the framework 160 can be used to provide directionality to the portion of cooling fluid 154 passing through the porous portion 146. Additionally, the framework 160 can meter the portion of cooling fluid 154 passing through the porous portion 146, as well as increase structural integrity where desirable. The framework 160 can be made of any material, such as a similar material to that of the rib or the porous material.

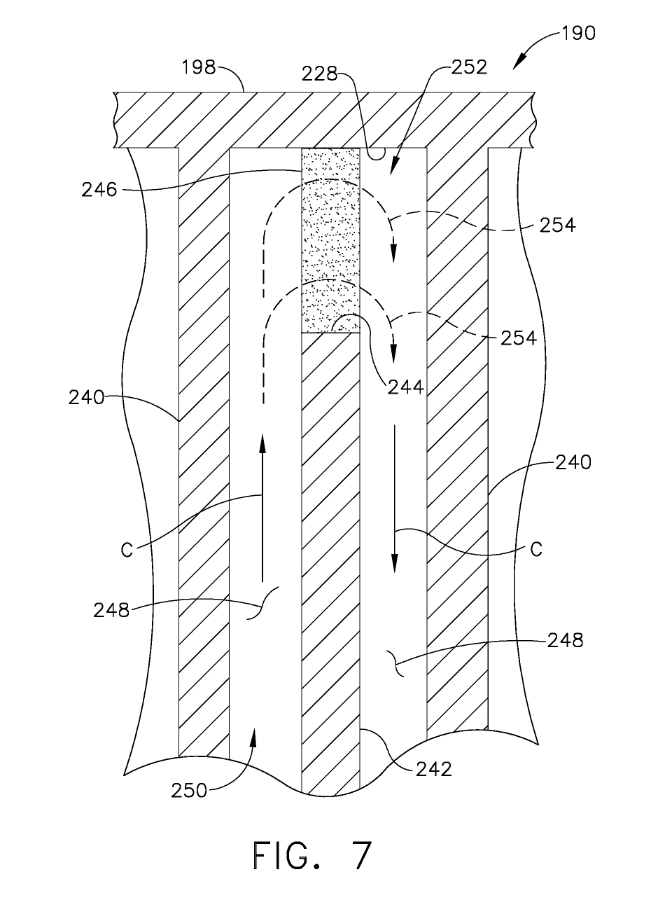

Referring now to FIG. 7, another example airfoil 190 is illustrated having a partial-length rib 242 connected to a tip 198 with a porous material 246. It should be appreciated that the airfoil 190 of FIG. 7 can be substantially similar to the airfoil 90 of FIGS. 4-6, and that similar elements will be identified with similar numerals increased by a value of one hundred.

The partial-length rib 242 terminates at a rib end 244 spaced from the tip 198 of the airfoil 190. The porous material 246 extends from the rib end 244 to a cooling surface 226 of the tip 198. A turn 252 is formed through the porous material 246. A portion of the cooling fluid 254 can pass through the porous material 246 in the turn 252 to pass from one flow channel 248 to the next.

It should be appreciated that the example illustrated in FIG. 7 can provide for increased structural integrity of the airfoil 190 while permitting the cooling fluid C to pass within a cooling circuit 250 within the airfoil 190. Additionally, it should be appreciated that the partial-length rib 242 having the porous material 246 connected to the tip 198 is effectively a full-length rib. As such, a porous material 246 formed in a full-length rib at the tip 198 can define the turn 252 for forming the cooling circuit 250.

It should be appreciated that the porous portions 146, 246 described in FIGS. 4-7 provide for reduced flow separation within cooling circuits, particularly in portions of the cooling circuit requiring drastic changes in flow direction such as a turn. The porous portions 146, 246 permit a volume of cooling air to pass through the partial-length ribs 142, 242 to reduce flow separation of the cooling fluid C passing through the turns within the cooling circuit. Additionally, the porous portions 146, 246 can be used to increase or maintain structural integrity of the airfoil 90, without increasing system weight or sacrificing cooling efficiency. The porous material 146, 246 can be significantly lighter than the other portions or materials used in constructing the airfoil 90.

A method of reducing flow separation within a cooling circuit within an airfoil for a turbine engine can include forming a portion of a partial-length rib with a porous material to permit a portion of a flow in the cooling circuit to pass through the partial-length rib. The cooling circuit can be the cooling circuit 150 formed within the airfoil 90. The partial-length rib 142, 242 includes the porous portion 146, 246 to permit a portion of the cooling fluid flow 154 to pass through the partial-length rib 142, 242.

In one example, the method can further include forming the end of the partial-length rib 142, such as shown in FIG. 4, with the porous portion 146. In another example, the porous portion 146 can be spaced from the end of the partial-length rib 142, such as that shown in FIGS. 5-6. Additionally, the method can include metering the portion of cooling fluid 154, 254 passing through the porous portions 146, 246. In non-limiting example, the metering can be accomplished by utilizing a structured porous material in the porous portions 146 or using framework 160, such as shown in FIG. 6.

It should be appreciated that such a method can reduce flow separation within the cooling circuit 150. Such flow separation is common at cooling circuit geometry such as turns, requiring a cooling fluid C to make a drastic turn, such as 180-degrees. Utilizing the porous material can permit a portion of the cooling fluid C to pass through the partial-length ribs 142, minimizing the amount of fluid required to make the turn, and reducing the flow separation at the turn. The reduced flow separation can improve cooling circuit efficiency that requires less cooling flow, which can improve overall engine efficiency.

It should be appreciated that while embodiments are shown for blade internal ribs, such designs could also apply to endwall and shroud cooling circuits, or other component containing internal flow passages or turns, appreciating that the concepts as described herein can have equal applicability in additional engine components, such as a vane, shroud, or combustion liner in non-limiting examples, and can be any region of any engine component requiring cooling, such as regions typically requiring film cooling holes or multi-bore cooling.

It should be further appreciated that the region having the porous portion can provide for improved cooling, such as providing improved directionality, metering, or local flow rates. Additionally, the porous material include in the region can further improve the cooling to an entire region beyond just the areas local to the porous material.

It should be appreciated that application of the disclosed design is not limited to turbine engines with fan and booster sections, but is applicable to turbojets and turbo engines as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An airfoil for a turbine engine, the airfoil comprising:
an outer wall bounding an interior and defining a pressure side and a suction side extending axially between a leading edge and a trailing edge to define a chord-wise direction and extending radially between a root and a tip to define a span-wise direction;
a cooling circuit located within the interior and having at least one rib that at least partially defines a flow channel; and
a porous material is provided in at least one rib to define a flow path through the at least one rib.

2. The airfoil of claim 1 wherein the at least one rib is a partial-length rib terminating in a rib end spaced from the tip or root to define a turn.

3. The airfoil of claim 2 wherein another porous material is provided in the partial-length rib.

4. The airfoil of claim 3 wherein the porous material is located at the rib end.

5. The airfoil of claim 3 wherein the porous material is spaced from the rib end.

6. The airfoil of claim 1 wherein the at least one rib is a full-length rib.

7. The airfoil of claim 1 wherein the at least one rib further includes a framework defining interstitial spaces, and the porous material is disposed in at least some of the interstitial spaces.

8. The airfoil of claim 1 wherein at least the porous material is formed by additive manufacturing.

9. The airfoil of claim 1 wherein the airfoil is one or a blade or a vane.

10. A component for a turbine engine, the component comprising:
a wall bounding an interior;
a cooling circuit located within the interior and having at least one rib that at least partially defines a flow channel; and
a porous material is provided in at least one rib to define a flow path through the at least one rib.

11. The component of claim 10 wherein the at least one rib is a partial-length rib terminating in a rib end that is spaced from the wall.

12. The component of claim 11 wherein another porous material is provided in the partial-length rib.

13. The component of claim 11 wherein the porous material is located at rib end.

14. The component of claim 11 wherein the porous material is spaced from the rib end.

15. The component of claim 10 wherein the at least one rib is a full-length rib.

16. The component of claim 10 wherein the at least one rib further includes a framework defining interstitial spaces, and the porous material is disposed in at least some of the interstitial spaces.

17. The component of claim 10 wherein at least the porous material is formed by additive manufacturing.

18. A method of reducing flow separation at a turn in a cooling circuit formed at least in part by a rib within an interior of an engine component for a turbine engine, the method comprising flowing cooling fluid through a porous material in the rib.

19. The method of claim 18 wherein the rib is a partial-length rib.

20. The method of claim 19 wherein the porous material is disposed on the end of the partial-length rib.

21. The method of claim 18 wherein flowing the cooling fluid through the porous material comprises flowing the cooling fluid through a structured porous material.

22. The method of claim 18 wherein flowing the cooling fluid through the porous material comprises flowing the cooling fluid through a non-structured porous material.

23. The method of claim 18 wherein the flowing the cooling fluid comprises metering the cooling fluid passing through the porous material.

24. The method of claim 18 wherein the porous material is formed by additive manufacturing.
